(19) United States
(12) Patent Application Publication
(10) Pub. No.: US 2005/0193401 A1
(43) Pub. Date: Sep. 1, 2005

(54) Disk protecting device for an optical recording and/or reproducing apparatus

(75) Inventors: Jui-Chiang Lin, Hsinchu City (TW); Tsung-Jung Kuo, Hsinchu City (TW)

Correspondence Address: BRUCE H. TROXELL, SUITE 1404, 5205 LEESBURG PIKE, FALLS CHURCH, VA, 22041, US

(73) Assignee: LITE-ON IT Corp.

(21) Appl. No.: 11/055,685

(22) Filed: Feb. 11, 2005

(30) Foreign Application Priority Data
Feb. 27, 2004 (TW) 93202949

(51) Int. Cl. G11B 17/04; G11B 17/03

(52) U.S. Cl. 720/624

(57) ABSTRACT

An optical recording and/or reproducing apparatus includes a disk protecting device having a stop member blocking an entrance-and-exit slot of the apparatus during the latter reads an optical disk.

### FIELD OF THE INVENTION

The invention relates to a disk protecting device, more particularly to a disk protecting device for an optical recording and/or reproducing apparatus of slot-in type.

### BACKGROUND OF THE INVENTION

An optical recording and/or reproducing apparatus of slot-in type is generally installed in a notebook computer or in an audio-and-video instrument of an automobile for reproducing the information recorded in an optical recording media, such as playing songs from a CD.

Referring to FIGS. 1 and 2, perspective, partly exploded and bottom views of a conventional optical recording and/or reproducing apparatus 2 of slot-in type are shown to include a casing formed with a disk entrance-and-exit slot 20, and a disk transport mechanism 6 disposed in the casing adjacent to the entrance-and-exit slot 20. The disk transport mechanism 6 includes an upwardly biased transport roller 61 and a guide member (not visible) that is disposed stationarily above the transport roller 61 and that slidably contacts the transport roller 61 by virtue of upwardly biased action of a spring. Under this condition, when an optical disk 4 is inserted between the guide member and the transport roller 61 via the entrance-and-exit slot 20, the optical disk 4 will be drawn into or ejected from the casing upon rotation of the transport roller 61 and due to applying force on the optical disk 4.

One disadvantage resulting from the use of the aforesaid conventional optical recording and/or reproducing apparatus resides in that the optical disk 4 may explode within the apparatus due to presence of scratches or stains on the information recording surface of the optical disk 4 or due to deformation in shape under the high rotation speed. The exploded parts may fly out from the slot 20, thereby injuring the user and nearby persons.

### SUMMARY OF THE INVENTION

The object of the present invention is to provide an optical recording and/or reproducing apparatus of slot-in type that is provided with a disk protecting device which is capable of blocking an entrance-and-exit slot of the optical recording and/or reproducing apparatus during reading operation of the optical disk.

In one aspect of the present invention, a disk protecting device for an optical recording and/or reproducing apparatus is provided. The optical recording and/or reproducing apparatus include a disk entrance-and-exit slot, and a transport roller. The transport roller is used for drawing into and ejecting an optical disk from the apparatus and is movable between an upper position, in which the transport roller is adapted to abut against the optical disk such that the optical disk is drawn into and ejected from the apparatus upon rotation of the transport roller, and a lower position, in which the transport roller is spaced apart from the optical disk. The disk protecting device includes: a rotary arm having a first end coupled pivotally to the transport roller so as to be movable together therewith, and a second end opposite to the first end; a connecting member having a first lateral side coupled to the second end of the rotary arm; and a stopping member connected to a second lateral side of the connecting member which is disposed adjacent to the entrance-and-exit slot, wherein the rotary arm is mounted within the apparatus in such a manner that movement of the transport roller from the upper position to the lower position results in turning of the rotary arm in a first direction so as to dispose the stop member parallel with and blocking the entrance-and-exit slot, and that movement of the transport roller from the lower position to the upper position results in turning of the rotary arm in a second direction opposite to the first direction, which in turn causes the stop member to move away from the entrance-and-exit slot.

In another aspect of the present invention, an optical recording and/or reproducing apparatus includes: an entrance-and-exit slot via which an optical disk is adapted to be inserted into or rejected from the apparatus; a transport roller used for drawing into and ejecting the optical disk from the apparatus, the transport roller being movable between an upper position, in which the transport roller is adapted to abut against the optical disk such that the optical disk is drawn into and ejected from the apparatus upon rotation of the transport roller, and a lower position, in which the transport roller is spaced apart from the optical disk (so as to dispose the optical disk in a readable condition); and a disk protecting device. The disk protecting device includes: a rotary arm having a first end coupled pivotally to the transport roller so as to be movable together therewith, and a second end opposite to the first end; a connecting member having a first lateral side coupled to the second end of the rotary arm; and a stopping member connected to a second lateral side of the connecting member which is disposed adjacent to the entrance-and-exit slot, the rotary arm being mounted in the apparatus in such a manner that movement of the transport roller from the upper position to the lower position results in turning of the rotary arm in a first direction so as to dispose the stop member parallel with and blocking the entrance-and-exit slot, and that movement of the transport roller from the lower position to the upper position results in turning of the rotary arm in a second direction opposite to the first direction, which in turn causes the stop member to move away from the entrance-and-exit slot.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a perspective view a conventional disk recording and/or reproducing apparatus;

FIG. 2 is a partly exploded and bottom view, illustrating an interior of the conventional disk recording and/or reproducing apparatus;

FIG. 3 is a partly exploded and bottom view, illustrating an interior of the preferred embodiment of an optical recording and/or reproducing apparatus according to the present invention;

FIG. 4 is fragmentary sectional view, illustrating how an optical disk is drawn into or ejected from the preferred embodiment of an optical recording and/or reproducing apparatus according to the present invention;

FIG. 5 is a perspective view of a disk protecting device employed in the preferred embodiment of an optical recording and/or reproducing apparatus according to the present invention;

FIG. 6 is a fragmentary sectional view, illustrating position of the disk protecting device, in which, the optical disk is readable by the preferred embodiment of an optical rerecording and/or reproducing apparatus according to the present invention; and

FIG. 7 is a perspective view of another disk protecting device employed in the preferred embodiment of an optical recording and/or reproducing apparatus according to the present invention.

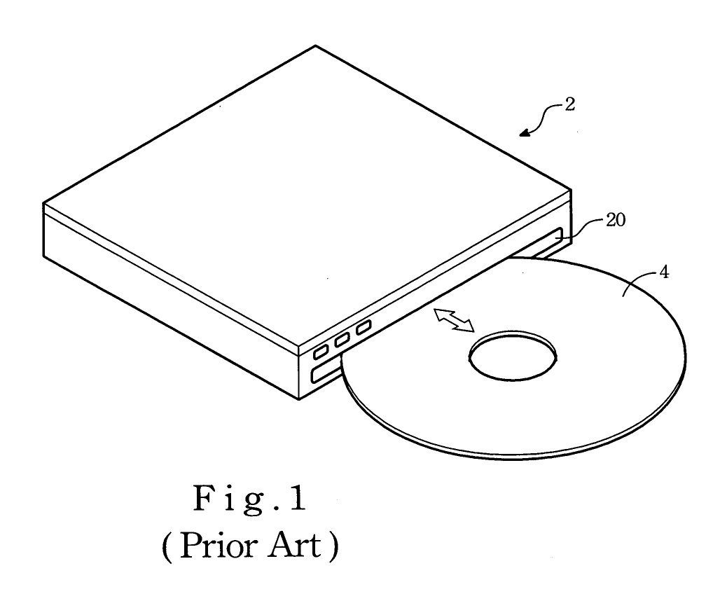

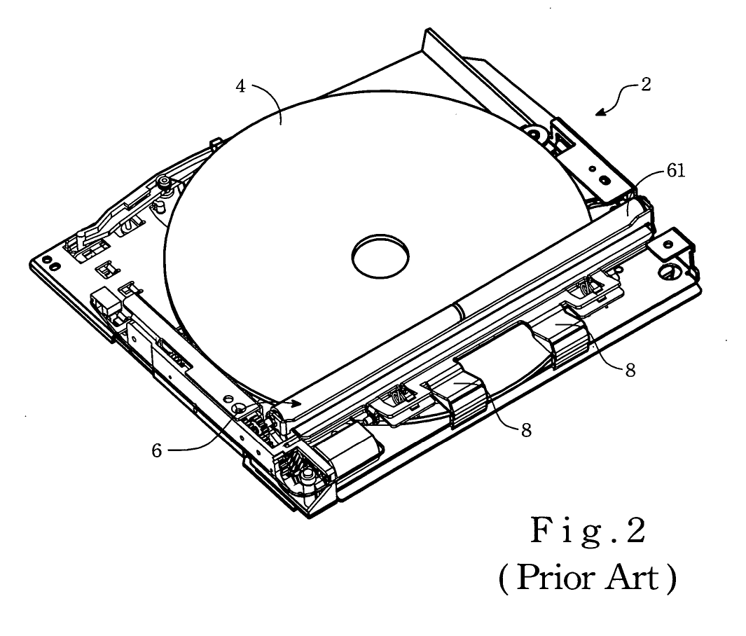

### DETAILED DESCCRIPTIONS OF THE PREFERRED EMBODIMENT

Before the present invention is described in greater, it should be noted that same reference numerals have been used to denote similar elements throughout the specification.

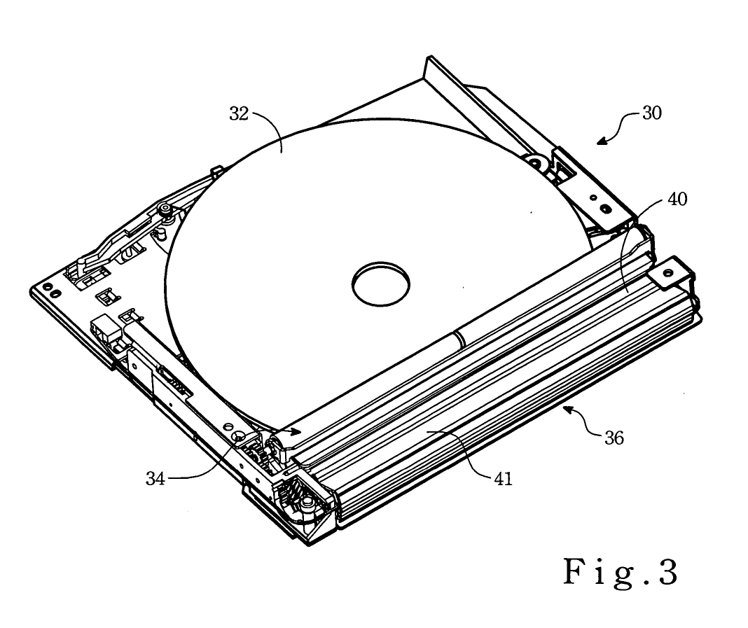

Referring to FIG. 3, a perspective partly exploded bottom view of the preferred embodiment of an optical recording and/or reproducing apparatus 30 according to the present invention is shown and generally installed in a notebook computer (not shown) or in an audio-and-video instrument of an automobile for reproducing the information recorded in an optical disk 32, such as playing out songs from a CD. The optical recording and/or reproducing apparatus is of slot-in type, and is a CD player.

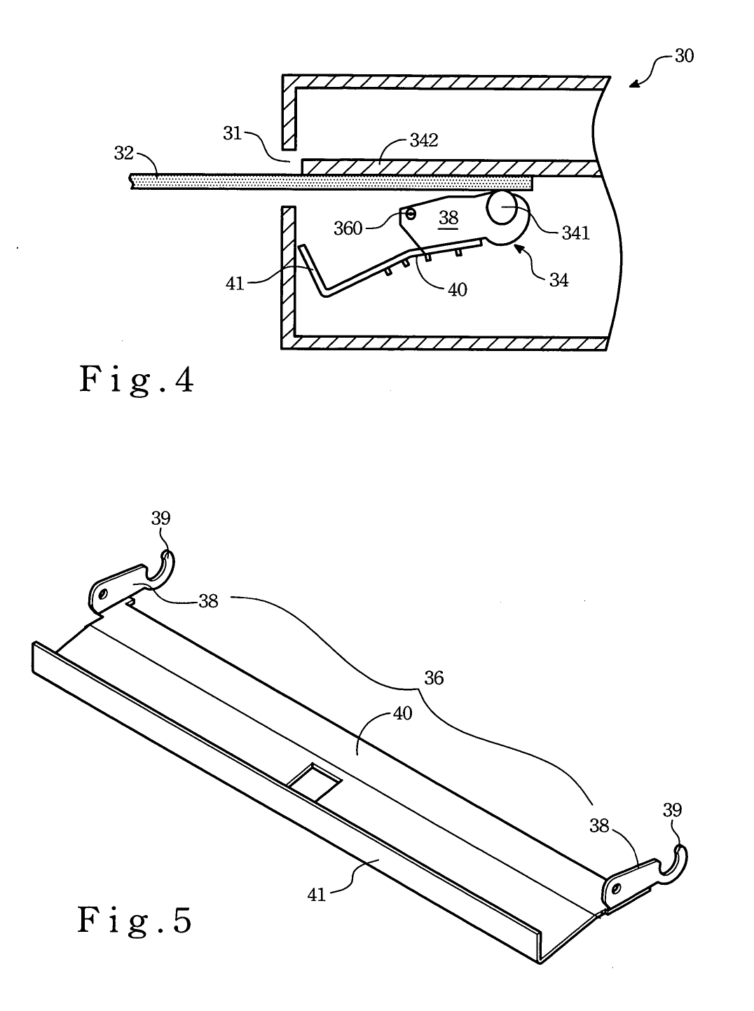

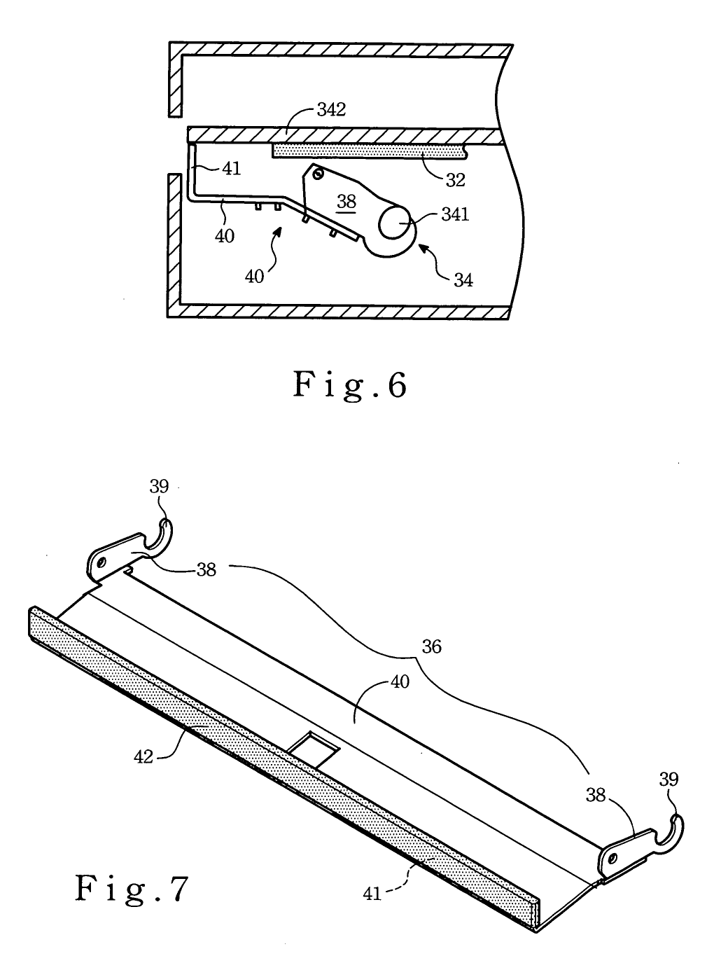

As illustrated in FIGS. 3 and 4, the apparatus 30 includes a casing formed with an entrance-and-exit slot 31, a disk transport mechanism 34, and a disk protecting device 36. The transport mechanism 34 includes a transport roller 3411 and a guide member 342 that is disposed stationarily above the transport roller 341. The transport roller 341 is mounted movably and rotatably within the casing for drawing into and ejecting an optical disk 32 from the casing. The transport roller 341 is movable between an upper position (see FIG. 4) by virtue of upwardly urging action of a spring (not shown), in which the transport roller 341 abuts against the optical disk 32 such that the optical disk 32 is drawn into and ejected from the casing upon rotation of the transport roller 341. The transport roller 341 is also movable to a lower position against the urging action of the spring, in which the transport roller 341 is spaced apart from the optical disk 32, thereby disposing the latter under a readable condition (see FIG. 6). Preferably, the transport roller 341 has an axial length greater than a longitudinal length of the entrance-and-exist slot 31 such that the transport roller 341 extends along the longitudinal length of the entrance-and-exit slot 31. Since the driving unit for moving the transport roller 341 between the upper and lower positions, is not the relevant feature of the present invention, detailed description of the same is omitted herein for the sake of brevity.

Referring to FIG. 5, the disk protecting device 36 includes two rotary arms 38, an elongated connecting member 40, a stopping member 41, and a pivot shaft 360. The rotary arms 38 are mounted in the casing via the pivot shaft 360, and have two first ends 39 coupled pivotally and respectively to opposite ends of the transport roller 34, and two second ends opposite to the first ends 39, respectively. Preferably, the first ends 39 of the rotary arms 38 are in hook configuration such that they are loosely sleeved around the opposite ends of the transport roller 341 so as to be movable together therewith when the transport roller 341 moves between the upper and lower positions. The connecting member 40 has a first lateral side coupled to the second ends of the rotary arms 38. The stopping member 41 is connected to a second lateral side of the connecting member 40, which is disposed adjacent to the entrance-and-exit slot 31. Preferably, the stop member 41 extends perpendicularly from the second lateral side of the connecting member 40.

Under such arrangement, movement of the transport roller 341 from the upper position to the lower position results in turning of the rotary arms 38 about the pivot shaft 360 in a first direction, thereby disposing the stop member 41 parallel with the entrance-and-exit slot 31, consequently abutting against the guide member 342 and blocking the entrance-and-exit slot 31. In case of breakup of the optical disk 32 during the reading operation due to elastically deformation of the disk 32 or other reasons, the stop member 41 will stop the broken parts. In the same manner, movement of the transport roller 341 from the lower position to the upper position results in turning of the rotary arms 38 about the pivot shaft 360 in a second direction opposite to the first direction, which in turn causes the stop member 41 to move away from the entrance-and-exit slot 31 (see FIG. 6).

Referring to FIG. 7, another disk protecting device 36 for the preferred embodiment of the optical recording and/or reproducing apparatus according to the present invention is shown to have a construction similar to the previous embodiment. The only difference resides in that an elastic sheath 42 is sleeved over the stop member 41 for providing buffering action in case of breakup of the optical disk 32 during the reading operation.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A disk protecting device for an optical recording and/or reproducing apparatus which includes a disk entrance-and-exit slot, and a transport roller, the transport roller being used for drawing into and ejecting an optical disk from the entrance-and-exit slot and being movable between an upper position, in which the transport roller is adapted to abut against the optical disk such that the optical disk is drawn into and ejected from the apparatus upon rotation of the transport roller, and a lower position, in which the transport roller is spaced apart from the optical disk so as to dispose the optical disk in a readable condition, the disk protecting device 6 comprising:
a rotary arm having a first end coupled pivotally to the transport roller so as to be movable together therewith, and a second end opposite to said first end;
a connecting member having a first lateral side coupled to said second end of said rotary arm; and
a stopping member connected to a second lateral side of said connecting member which is disposed adjacent to the entrance-and-exit slot, wherein said rotary arm is mounted within the apparatus in such a manner that movement of the transport roller from the upper position to the lower position results in turning of said rotary arm in a first direction so as to dispose said stop member blocking the entrance-and-exit slot, and that movement of the transport roller from the lower position to the upper position results in turning of said rotary arm in a second direction opposite to said first direction, which in turn causes said stop member to move away from the entrance-and-exit slot.

2. The disk protecting device for an optical recording and/or reproducing apparatus according to claim 1, wherein said disk protecting device comprises two of said rotary arms having two of said first ends respectively and pivotally connected to opposite ends of the transport roller, said second ends of said rotary arms being fixed to said first lateral side of said connecting member.

3. The disk protecting device for an optical recording and/or reproducing apparatus according to claim 1, wherein said stop member 41 extends perpendicularly from said second lateral side of said connecting member 40.

4. The disk protecting device for an optical recording and/or reproducing apparatus according to claim 1, wherein the transport roller has an axial length greater than a longitudinal length of the entrance-and-exist slot such that the transport roller extends along the longitudinal length of the entrance-and-exit slot.

5. The disk protecting device for an optical recording and/or reproducing apparatus according to claim 1, further comprising an elastic sheath sleeved over said stop member for providing buffering action.

6. The disk protecting device for an optical recording and/or reproducing apparatus according to claim 1, wherein the optical disk is a CD.

7. The disk protecting device for an optical recording and/or reproducing apparatus according to claim 1, wherein the optical recording and/or reproducing apparatus is a CD player.

8. The disk protecting device for an optical recording and/or reproducing apparatus according to claim 1, wherein said disk protecting device comprises two of said rotary arms having two of said first ends respectively and pivotally connected to opposite ends of the transport roller, said second ends of said rotary arms being fixed to said first lateral side of said connecting member.

9. An optical recording and/or reproducing apparatus comprising:
an entrance-and-exit slot via which an optical disk is adapted to be inserted into or rejected from the apparatus;
a transport roller used for drawing into and ejecting the optical disk from said entrance-and-exit slot, said transport roller being movable between an upper position, in which the transport roller is adapted to abut against the optical disk such that the optical disk is drawn into and ejected from the apparatus upon rotation of the transport roller, and a lower position, in which the transport roller is spaced apart from the optical disk so as to dispose the optical disk in a readable condition; and
a disk protecting device including:
a rotary arm having a first end coupled pivotally to said transport roller so as to be movable together therewith, and a second end opposite to said first end,
a connecting member having a first lateral side coupled to said second end of said rotary arm, and
a stopping member connected to a second lateral side of said connecting member which is disposed adjacent to said entrance-and-exit slot, said rotary arm being mounted in the apparatus in such a manner that movement of said transport roller from said upper position to said lower position results in turning of said rotary arm in a first direction so as to dispose said stop member blocking said entrance-and-exit slot, and that movement of said transport roller from said lower position to said upper position results in turning of said rotary arm in a second direction opposite to said first direction, which in turn causes said stop member to move away from the entrance-and-exit slot.

10. The optical recording and/or reproducing apparatus according to claim 9, wherein said stop member extends perpendicularly from said second lateral side of said connecting member.

11. The optical recording and/or reproducing apparatus according to claim 9, wherein said transport roller has an axial length greater than a longitudinal length of said entrance-and-exist slot such that said transport roller extends along the longitudinal length of said entrance-and-exit slot.

12. The optical recording and/or reproducing apparatus according to claim 9, further comprising an elastic sheath sleeved over said stop member for providing buffering action.

13. The optical recording and/or reproducing apparatus according to claim 9, wherein the optical disk is a CD.

14. The optical recording and/or reproducing apparatus according to claim 1, wherein the optical recording and/or reproducing apparatus is a CD player.
